(19) United States
(12) Patent Application Publication
(10) Pub. No.: US 2008/0181531 A1
(43) Pub. Date: Jul. 31, 2008

(54) Emboldening glyphs without causing conglutination

(75) Inventor: Edward Otto Platz, Methuen, MA (US)

Correspondence Address: BREINER & BREINER, L.L.C., P.O. BOX 320160, ALEXANDRIA, VA, 22320-0160, US

(73) Assignee: Monotype Imaging Inc., Woburn, MA (US)

(21) Appl. No.: 11/657,588

(22) Filed: Jan. 25, 2007

(51) Int. Cl. G06K 9/40

(52) U.S. Cl. 382/274

(57) ABSTRACT

A method is provided for emboldening a bitmap character, which includes using a bitmap for a character to be emboldened and selectively turning on pixels of the bitmap of the character, which are initially off, based on whether the pixels are immediately adjacent to an initially off pixel. The bitmap character to be emboldened can either be an embedded font character or the character can be generated from a glyph stroke or outline which is scaled to a desired size. The method is applied to all base pixels which form the character until the entire character is emboldened.

### FIELD OF THE INVENTION

The present invention relates to a method and system for font character rendering and, in particular, a method and system for rendering emboldened font characters.

### BACKGROUND OF THE INVENTION

The appearance and layout of a typical text document, e.g., a word processing document or media presentation document, is determined by the selection of fonts used to display the characters which comprise the text document. To accurately render a text document, often it is necessary to vary the size or resolution of the font and/or vary the font from normal style to boldface depending on how the character is used in the document.

Prior methods for rendering font characters include the use of mathematical algorithms to scale font characters and render the characters at various sizes and resolutions. One type or family of fonts which are mathematically scalable are TrueType fonts. In TrueType fonts, each character form, referred to as a glyph, contains instructions for generating a respective glyph outline or strokes of the glyph at a desired size. Subsequently, the glyph is rasterized or filled in. If a bold or heavier version of the glyph is desired, traditionally the method for emboldening the glyph is to embolden the outline or stroke of a glyph before rasterization of the glyph.

Another prior art method of emboldening font characters or glyphs is to embolden a bitmap by turning on initially “off” pixels, and is shown in FIGS. 1(a)-1(c), in which FIG. 1(a) depicts a glyph as a normal style font, FIG. 1(b) depicts a first level of emboldeness of the glyph of FIG. 1(a), and FIG. 1(c) depicts the glyph of FIG. 1(a) with a second level of emboldeness. In this prior art method, emboldening glyphs includes turning on an initially “off” pixel adjacent to each respective initially “on” pixel, referred to as a “base pixel,” resulting in a first level of emboldeness, as shown in FIG. 1(b). A second level of emboldeness turns on an initially “off” pixel to the left and to the right of each respective base pixel, resulting in a second level of emboldeness depicted in FIG. 1(c).

Specifically referring to FIG. 1(a), the bitmap of normal style glyph 10 is composed of a plurality of pixels which are turned on. For example, the top row of the bitmap of the normal style glyph 10 includes pixels 11a-11m where pixel 11a is in the first column position of the top row of the bitmap, 11b is in the second column position of the top row, 111 is in the second to last position of the top row, and pixel 11m is in the last column position of the top row. Similarly, referring to the second row, pixel 14 is in a first column position with regard to the second row. As previously noted, a first level of emboldeness is generated using the prior art method by turning on a pixel adjacent to a respective base pixel, when the pixel adjacent to the base pixel is initially “off.” For example, in FIG. 1(a), pixel 12, the pixel to the left of pixel 11a, is initially off, as indicated by a not filled box. Accordingly, pixel 12′ is turned on, as indicated by a filled box in the emboldened glyph 20 of FIG. 1(b). Similarly, in normal glyph 10 (FIG. 1(a)), base pixel 14 is “on,” and the pixel to its immediate left, pixel 15, is “off.” Accordingly, in the emboldened glyph 20, pixel 15′ is turned “on” (FIG. 1(b)).

Referring now to FIG. 1(c), a second level of emboldeness is provided by the prior art method by turning on both a pixel to the left and right of a base pixel when the pixel to the immediate left and immediate right of a base pixel respectively is initially “off.” For example, pixels 15 and 16 to the left and right respectively of base pixel 14 (FIG. 1(a)), which are initially “off,” are turned on in second level emboldened glyph 30, as shown in FIG. 1(c).

One disadvantage with the prior art methods is that if a bold or heavier version of a glyph is desired, conglutination of complex characters can occur. Conglutination is observable when comparing normal style glyph 10 (FIG. 1(a)) with emboldened glyph 20 (FIG. 1(b)) as well as with emboldened glyph 30 (FIG. 1(c)). Similarly, conglutination is observed when using the method of emboldening the outline or stroke before rasterization.

There is a need in the art for a new and improved method for emboldening glyphs in a font set at a desired size without causing conglutination of glyph characters.

### SUMMARY OF THE INVENTION

The present invention relates to a method and system for rendering glyph characters in a font set at a desired size and emboldening those glyph characters without causing conglutination. The invention involves intelligently modifying a bitmap, wherein the bitmap may be a fully rasterized bitmap for a character or a bitmap during rasterization to provide a character.

In one form, the method includes using a fully rasterized bitmap of the character to be emboldened and selectively turning on pixels of the bitmap which comprise the character, which initially are off, and adjacent to initially on pixels based on whether one or two of the immediately adjacent pixels to one side of the initially on pixel are off.

In addition to using a fully rasterized bitmap of a glyph, the method can also be applied to a bitmap during rasterization which generates a fully rasterized bitmap of the glyph at a desired size. On a pixel-by-pixel basis, for each “on”0 pixel, referred to herein as a “base pixel,” respective immediately adjacent off pixels are turned on, depending on whether one or two pixels to one side of the base pixel is/are off. The method is applied to all base pixels ultimately forming the fully rasterized glyph until the entire glyph is emboldened.

The present invention, in one form thereof, relates to a method for emboldening bitmap characters, referred to as glyphs, by providing a bitmap of a character to be emboldened and selectively turning on pixels of the bitmap which are initially off and which are adjacent to the initially on base pixel based on whether one or two of the immediately adjacent pixels to one side of the respective base pixel is/are off.

In one specific form of the method, the bitmap is generated for the character by scaling an outline or stroke set of the character to a desired size and rasterizing the character without emboldening the outline or stroke of the character first. Alternatively, a specific bitmap may already exist for the desired size of the character to be emboldened as an embedded normal style character or glyph.

In one specific form of the present invention, the respective pixels to one side of the base pixel are selectively turned on based on the following criteria:

i. adding a new bit column to the left or right of a respective base pixel if the base pixel is in a first column or last column position, respectively, of a given row in the bitmap of the glyph, and turning on a respective pixel in the new bit column;

ii. turning on a pixel to the left or right of a respective base pixel if the respective base pixel is in the second column position from the left or the right for a given row in the bitmap and the pixel to the left or right, respectively, is initially off; and

iii. turning on the pixel to the left or right if the respective base pixel is in any other column other than the first or second column from either end of a given row in the bitmap, and the two pixels to the left or right, respectively, of the base pixel are off.

In one further form, the present method is applied to both pixels to the left and the right of the base pixel, thus generating a second level of emboldeness.

In another further form, the present invention is applied to the pixel to the left or right and subsequently applied again, the second application being applied in the opposite direction of the first pass, thus generating a second level of emboldeness.

In an alternative method, a similar process can be applied to pixels adjacent the base pixel which are either above, below, or both above and below the base pixel to create a first and/or second level of emboldened glyph.

### BRIEF DESCRIPTION OF THE DRAWING

FIG. 1(a)-1(c) depict a prior art method of emboldening a glyph where FIG. 1(a) represents a normal style glyph, FIG. 1(b) is a first level of emboldened glyph, and FIG. 1(c) is a second level of emboldened glyph of the glyph of FIG. 1(a);

FIGS. 2(a)-2(c) comprise bitmaps of a glyph rendered as normal, first level, and second level emboldeness, respectively, in accordance with the present invention; and

FIG. 3 is a flow chart, in accordance with the present invention.

### DETAILED DESCRIPTION

The present invention overcomes the sometimes undesirable limitation of prior art methods of emboldening glyphs in a font set leading to conglutination by selectively turning on pixels, starting from a fully rasterized bitmap of a normal style glyph.

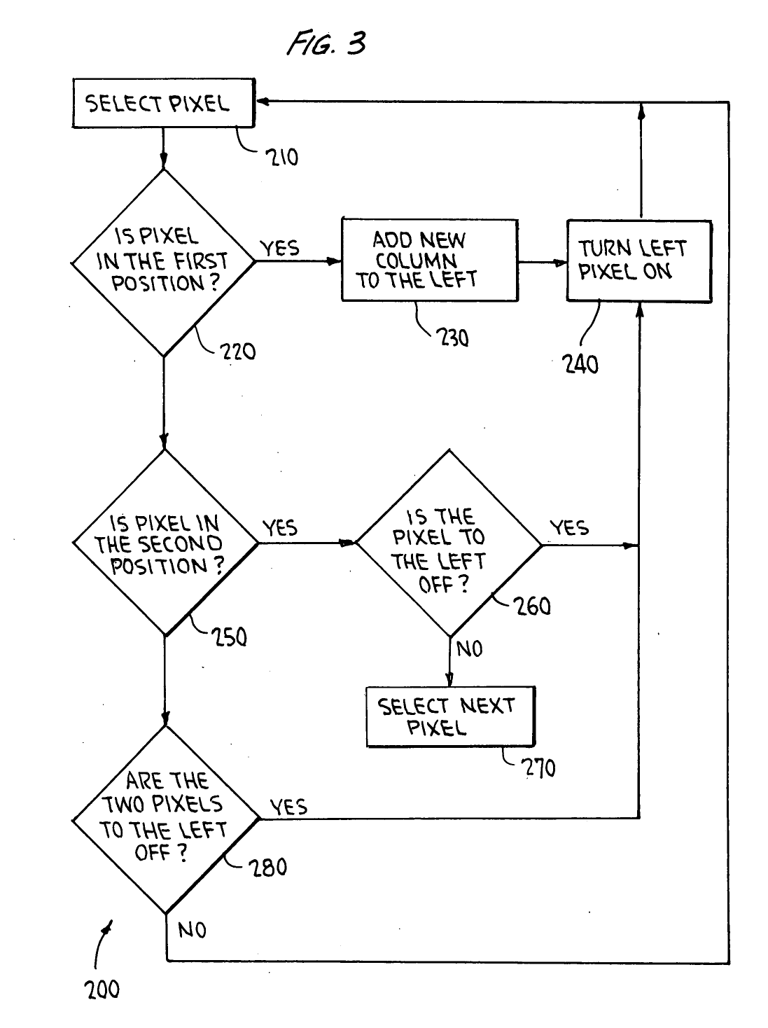

Referring now to FIG. 2(a), normal style glyph 110 is shown as a fully rasterized bitmap comprised of a plurality of pixels, which are either turned on, shown as filled squares, or off, shown as unfilled squares. For example, the first row of glyph 110 includes on pixels 11a-11m and a second row comprises on pixel 114g.

The bitmap 110 either can be embedded in a font set associated with a document to be printed or rendered on a display screen, or the bitmap 110 may be generated by scaling a scalable font, such as a TrueType font. For example, if a bitmap is not embedded, i.e. a bitmap does not already exist, a bitmap is generated from outline or stroke data and fully rasterized, as is conventional in the art.

Next, using the present method, the bitmap 110 is made bolder by intelligently replicating pixels, e.g., in the horizontal, left direction, to generate a first level of emboldeness of glyph 120, FIG. 2(b), and from both the left and right direction to generate a second level of emboldness of glyph 130, FIG. 2(c).

Referring now to the flow chart of FIG. 3, along with FIGS. 2(a)-2(c), embedding method 200 intelligently replicates pixels, starting with each “on” or “base pixel” (step 210), and then examines the “on” or “off” status of pixels to the immediate left and/or two pixels to the left of the base pixel. If the base pixel is in the first column position for a given row of the bitmap (step 220), a new column is added to the left of the base pixel (step 230) and that pixel is turned on (step 240). For example, base pixel 11a is in the first column position for the top row of the bitmap which comprises the glyph 110 (FIG. 2(a)). Therefore, a new column is added to its left and pixel 112 is turned on, as shown in FIG. 2(b) in glyph 120.

If the base pixel is in the second column position of a given row which comprises the bitmap (step 250), and the pixel to its left is initially off (step 260), then that pixel to the left of the base pixel is turned on. For example, pixel 117b is in the second column position for its row and pixel 117a is off (FIG. 2(a)). Therefore, pixel 117a′ is turned on in the emboldened glyph 120 (FIG. 2(b)). However, if the base pixel is in the second column position, but the pixel to its left is on (step 260), the method 200 is repeated (step 270) and a next base pixel is selected (step 210). For example, pixel 111b is in the second column position for the top row, and the pixel to its left, pixel 111a, is on. Therefore, the method is repeated for a next base pixel.

If the base pixel is in any other column position other than the first or second position for a given row, and there are two off pixels to the left of the base pixel (step 280), then the pixel immediately to the left of the base pixel is turned on. For example, pixel 114g is not in the first or second column position for its row, and pixel 114g has two pixels to its left which are off, namely 114e and 114f. Therefore, the pixel to the immediate left, pixel 114f′, is turned on in the bitmap of emboldened glyph 120 (FIG. 2(b)). Pixel 118d is in the fourth column position of its row and, thus, not in the first or second position in its row. However, there is only one pixel to its left which is off, namely pixel 118c, while pixel 118b is on (FIG. 2(a)). Therefore, in the emboldened glyph 120, pixel 118c is not turned on since there are not two off pixels to the left of pixel 118d.

Method 200 is then repeated by being applied to each “on” or base pixel of the bitmap 110 to generate the first level emboldened glyph 120.

A second level of emboldeness is achieved by using a similar method to selectively turn on pixels to the right of the base pixel, applying the same rules as method 200, but instead to pixels to the right of the base pixel, to generate emboldened glyph 130. For example, base pixel 111m is in a first column position from the right in the top row of the bitmap. Therefore, a new column is added to the right of pixel 111m and pixel 113 is turned on (FIG. 2(c)). Further, base pixel 114g is not in the first column position or in the second column position of its row and there are two off pixels to its right, pixels 114h and 114i, in the normal style glyph 110 and, therefore, pixel 114h′ is turned on in second level emboldened glyph 130. Similarly, pixel 118d has two pixels to its right, which are initially off, namely pixels 118e and 118f (FIG. 2(a)) and, therefore, pixel 118e′ is turned on in emboldened glyph 130 (FIG. 2(c)).

The present method can be described in an alternative manner using the notation that “X” indicates an “on” pixel and “O” indicates an “off” pixel. For example, “OOX” becomes “OXX” when performing a first level of emboldenness in accordance with the present invention. In another example, the following transformations would occur when emboldening a glyph in accordance with the present invention:

base form/normal style—XOOXOXXXOOOX

first level emboldeness—XXOXXOXXXOOXX

second level emboldeness—XXOXXOXXXXOXXX

Although the present invention has been described with regard to emboldening a glyph by turning on initially off pixels to the left, right or both in the bitmap of a base glyph, the same method can be applied to pixels above or below a base pixel which are initially in an “off” condition, using the same rules described herein.

Yet further to the above, the same method of the invention can also be applied to pixels wherein “right” can be used to provide a first order of emboldeness and, thereafter, “left” can be applied to provide further emboldening.

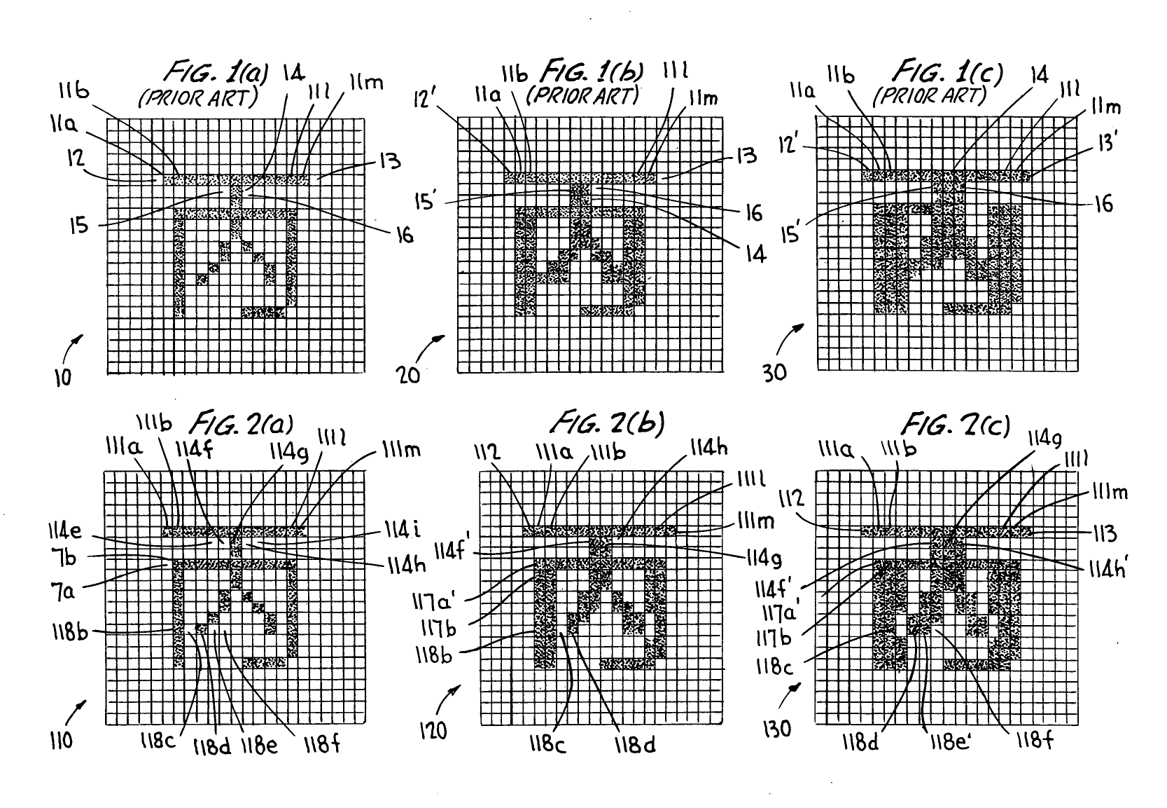

It will now be apparent to one of ordinary skill in the art that the present method provides a more pleasing rendered emboldened glyph than the prior art methods. For example, while the prior art method results in a conglutination of complex glyph characters, the present method provides for a more pleasing, truer rendering of an emboldened font, which is evident when comparing the prior art emboldened glyphs of FIGS. 1(b)-1(c) with the emboldened glyphs of FIGS. 2(b)-2(c) of the invention.

Although the invention has been described above in relation to preferred embodiments thereof, it will be understood by those skilled in the art that variations and modifications can be effected in these preferred embodiments without departing from the scope and spirit of the invention.

It is claimed:

1. A method for emboldening bitmap characters, said method comprising:
providing a bitmap for a character to be emboldened; and
selectively turning on pixels of the bitmap of the character, which initially are off, which initially off pixels are adjacent to initially on base pixels, based on whether one or two of the immediately adjacent pixels to one side of the respective base pixel are off.

2. The method of claim 1, wherein the providing a bitmap comprises generating a bitmap of the character by scaling one of an outline of the character or a stroke set of the character to a desired size and rasterizing the character without emboldening the outline or stroke of the character first.

3. The method of claim 1, wherein the providing a bitmap comprises generating a bitmap of the character by scaling one of an outline of the character or a stroke set of the character to a desired size and, during rasterization to provide the character, said selectively turning on pixels occurs to provide emboldening of the outline or the stroke of the character.

4. The method of claim 1, wherein the providing a bitmap comprises using an embedded bitmap of the character.

5. The method of claim 1, wherein said selectively turning on pixels comprises:
i. adding a new bit column left or right of a respective base pixel in the bitmap if the base pixel is in a first column position or a last column position, respectively, for a given row in the bitmap, and turning on a respective pixel in the new bit column;
ii. turning on a pixel left or right of a respective base pixel if the respective base pixel is in the second column position from either end of a respective row in the bitmap and a pixel left or right of the base pixel, respectively, is off; and
iii. turning on a pixel left or right only if the respective base pixel is in any other column other than the first column or the second column from either end of a respective row in the bitmap, and two pixels to the left or right, respectively, of the base pixel are off.

6. The method of claim 1, wherein said selectively turning on pixels comprises:
i. adding a new bit column left of a respective base pixel if the base pixel is in a first column position in a respective row of the bitmap and adding a new bit column right of a respective base pixel if the base pixel is in a last column position of a respective row in the bitmap;
ii. turning on a pixel left and right of a respective base pixel if the respective base pixel is in the second column position to a left end of a respective row in the bitmap or a right end of a respective row in the bitmap and a pixel left or right, respectively, is off; and
iii. turning on a pixel left and right only if the respective base pixel is in any other column other than the first column position or the second column position from either the left end or the right end of a respective row in the bitmap, and two pixels left or right, respectively, of the base pixel are off.

7. The method of claim 1, wherein said selectively turning on pixels comprises:
i. adding a new bit row above or below a respective base pixel if the base pixel is in a first row or a last row in a respective column in the bitmap, and turning on a respective pixel in the new bit row;
ii. turning on a pixel above or below a respective base pixel if the respective base pixel is in a second row position from top or bottom of a respective column in the bitmap, and a pixel above or below, respectively, is off; and
iii. turning on a pixel above or below the base pixel only if the respective base pixel is in any other row other than the first row or the second row from either end of a respective column in the bitmap, and two pixels above or below, respectively, of the base pixel are off.

8. A computer readable medium comprising computer executable instruction for: providing a bitmap for a character to be emboldened; and
selectively turning on pixels of the bitmap of the character, which initially are off, which initially off pixels are adjacent to initially on base pixels, based on whether one or two of immediately adjacent pixels to one side of the base pixel are off.

9. The computer readable medium of claim 8, wherein instruction for providing the bitmap comprises generating a bitmap of the character by scaling one of an outline of the character or a stroke set of the character to a desired size and then rasterizing the character without emboldening the outline or the stroke of the character first.

10. The computer readable medium of claim 8, wherein instruction for providing the bitmap comprises generating a bitmap of the character by scaling one of an outline of the character or a stroke set of the character to a desired size and then, during rasterization to provide the character, said selectively turning on pixels occurs to provide emboldening of the outline or the stroke set of the character.

11. The computer readable medium of claim 8, wherein instruction for providing the bitmap comprises using an embedded bitmap of the character.

12. The computer readable medium of claim 8, wherein the instruction for said selectively turning on pixels comprises:
i. adding a new bit column left or right of a respective base pixel in the bitmap if the base pixel is in a first column position or a last column position, respectively, for a given row in the bitmap, and turning on a respective pixel in the new bit column;
ii. turning on a pixel left or right of a respective base pixel if the respective base pixel is in a second column position from either end of a respective row in the bitmap and a pixel left or right of the base pixel, respectively, is off; and
iii. turning on a pixel left or right only if the respective base pixel is in any other column other than the first column or the second column from either end of a respective row in the bitmap, and two pixels left or right, respectively, of the base pixel are off.

13. The computer readable medium of claim 8, wherein instruction for selectively turning on pixels comprises:
i. adding a new bit column left of a respective base pixel if the base pixel is in a first column position in a respective row of the bitmap and adding a new bit column right of a respective base pixel if the base pixel is in a last column position of a respective row in the bitmap;
ii. turning on a pixel left and right of a respective base pixel if the respective base pixel is in a second column position to a left end of a respective row in the bitmap or a right end of a respective row in the bitmap and a pixel left or right, respectively, is off; and
iii. turning on a pixel left and right only if the respective base pixel is in any other column other than the first column position or the second column position from either a left end or a right end of a respective row in the bitmap, and two pixels left or right, respectively, of the base pixel are off.

14. The computer readable medium of claim 8, wherein instruction for said selectively turning on pixels comprises:
i. adding a new bit row above or below a respective base pixel if the base pixel is in a first row or a last row in a respective column in the bitmap, and turning on a respective pixel in the new bit row;
ii. turning on a pixel above or below a respective base pixel if the respective base pixel is in a second row position from top or bottom of a respective column in the bitmap, and a pixel above or below, respectively, is off; and
iii. turning on a pixel above or below the base pixel only if the respective base pixel is in any other row other than the first row or the second row from either end of a respective column in the bitmap, and two pixels above or below, respectively, of the base pixel are off.
